(19) United States
(12) Patent Application Publication
(10) Pub. No.: US 2010/0131864 A1
(43) Pub. Date: May 27, 2010

(54) AVATAR PROFILE CREATION AND LINKING IN A VIRTUAL WORLD

(76) Inventors: Brian R. Bokor, Raleigh, NC (US); Andrew B. Smith, Morrisville, NC (US); Steven K. Speicher, Apex, NC (US)

Correspondence Address: MOORE & VAN ALLEN, PLLC For IBM, P.O. Box 13706, Research Triangle Park, NC, 27709, US

(21) Appl. No.: 12/275,726

(22) Filed: Nov. 21, 2008

(51) Int. Cl. G06F 3/048

(52) U.S. Cl. 715/757; 715/700; 715/810

(57) ABSTRACT

A method for creating and linking a profile in a virtual world may include presenting an interface for creating a grouping profile for application to a user's avatar in response to the user's avatar to be transported to one of a particular virtual world location, event or activity. The grouping profile may include at least one attribute. The method may also include allowing assignment of the at least one attribute to the grouping profile and allowing definition of an application criteria. The method may further include associating the application criteria with the grouping profile, wherein the application criteria is usable to determine if the grouping profile is applicable to the user's avatar based on the one of the particular virtual world location, event and activity to which the user's avatar is to be transported.

### BACKGROUND

The present invention relates to virtual worlds, such as simulations of the real-world or real-life, and the like, and more particularly to avatar profile creation and linking in a virtual world, such as allowing grouping of avatar attributes, including grouping gestures, clothing, moods, appearance, accessories, equipment, or other avatar attributes, that may be associated with or linked to events and/or locations in a virtual world.

Computer based simulations are becoming more ubiquitous. Simulations may be used for training purposes, for entertainment, for commerce or for other purposes. Computer simulations such as Second Life or similar simulations present a virtual world which allows users or players to be represented by characters known as avatars. Second Life is an Internet-based virtual world launched in 2003 by Linden Research, Inc. A downloadable client program called the Second Life Viewer enables users, called “Residents”, to interact with others in the virtual world through motional avatars. The virtual world basically simulates the real world or environment. The users or residents via their avatar can explore the virtual world, meet other users or residents, socialize, participate in individual and group activities, create and trade items (virtual property) and services from one another. The challenge with respect to such simulations or virtual worlds is to make them as realistic or as much like the real-world or real-life as possible. This increases the utility of such simulations as a training tool or enjoyment of the participants or users as an entertainment medium. Current virtual worlds enable only certain limited capabilities for simulating real-world interactions such as personalization of avatars based on clothing, facial features and physique. More engaging experiences, such as moods or emotions are typically not taken into account. For example, how moods are defined and affect personal features, such as dress, facial expressions or other features, and personal interactions is lacking. Second Life is a trademark of Linden Research, Inc. in the United States, other countries or both.

In addition, in the virtual world, the user may enable several layers of configuration for an avatar. These can range from clothing, skin color, body size and shape, moods, scripts, and the like. It should be noted that applicants are aware of a previously filed application directed to managing mood effects. It is the subject of U.S. patent application Ser. No. 11/971,508 filed Jan. 9, 2008, and is incorporated herein by reference in its entirety. At present, the user may manage the individual attributes in their inventory. However, there is no known method or system of creating a grouping of such attributes and associating them with an event or location in the virtual world.

It is tedious and time consuming to manage each attribute presently. The current method requires the user to knowingly assign the appropriate configuration values prior to teleporting to an activity that requires a certain level of configuration for dress, gestures, moods, etc. This may account for the lower return rates for new users in virtual worlds. Lowering the barrier of usability or manageability of these attributes for users may result in improved user experience and possibly higher rates of return users.

### BRIEF SUMMARY

In accordance with one aspect of the present invention, a method for creating and linking a profile in a virtual world may include presenting an interface for creating a grouping profile for application to a user's avatar in response to the user's avatar to be transported to one of a particular virtual world location, event or activity. The grouping profile may include at least one attribute. The method may also include allowing assignment of the at least one attribute to the grouping profile and allowing definition of an application criteria. The method may further include associating the application criteria with the grouping profile, wherein the application criteria is usable to determine if the grouping profile is applicable to the user's avatar based on the one of the particular virtual world location, event and activity to which the user's avatar is to be transported.

In accordance with another aspect of the present invention, a system for creating and linking a profile in a virtual world may include a processor. A module is operable on the processor for creating and linking a grouping profile in the virtual world. An interface may be presented by the module for creating a grouping profile for application to a user's avatar in response to the user's avatar to be transported to one of a particular virtual world location, event or activity. The grouping profile includes at least one attribute. The module allows assignment of the at least one attribute to the grouping profile. The module also allows definition of application criteria. The module further permits association of the application criteria with the grouping profile. The application criteria is usable to determine if the grouping profile is applicable to the user's avatar based on one of the particular virtual world location, event and activity to which the user's avatar is to be transported.

In accordance with another aspect of the present invention, a computer program product for creating and linking a profile in a virtual world may include a computer usable medium having computer usable program code embodied therein. The computer usable medium may include computer usable program code configured to present an interface for creating a grouping profile for application to a user's avatar in response to the user's avatar to be transported to one of a particular virtual world location, event or activity, wherein the grouping profile includes at least one attribute. The computer useable medium may also include computer usable program code configured to allow assignment of the at least one attribute to the grouping profile. The computer useable medium may also include computer usable program code configured to allow definition of application criteria. The computer useable medium may further include computer usable program code configured to associate the application criteria with the grouping profile, wherein the application criteria is usable to determine if the grouping profile is applicable to the user's avatar based on the one of the particular virtual world location, event and activity to which the user's avatar is to be transported.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a flow chart of an example of a method for avatar profile creation and linking in a virtual world in accordance with an embodiment of the present invention.

FIG. 2 is an example of a graphical user interface for avatar profile creation and linking in a virtual world in accordance with an embodiment of the present invention.

FIG. 3 is an illustration of a tagging mechanism or visual identifier to present a grouping profile of a user's avatar in the virtual world in accordance with an embodiment of the present invention.

FIG. 4 is an example of a system including a representation of an inventory of grouping profiles and mechanism for linking or associating the profiles based on application criteria in accordance with an embodiment of the present invention.

FIG. 5 is a block schematic diagram of a system for creating a grouping profile and linkage in a virtual world in accordance with an embodiment of the present invention.

### DETAILED DESCRIPTION

As will be appreciated by one of skill in the art, the present invention may be embodied as a method, system, computer program product, or a combination of the foregoing. Accordingly, the present invention may take the form of an entirely hardware embodiment, an entirely software embodiment (including firmware, resident software, micro-code, etc.) or an embodiment combining software and hardware aspects that may generally be referred to herein as a “circuit,” “module,” or “system.” Furthermore, the present invention may take the form of a computer program product embodied in any tangible medium of expression having computer-usable program code embodied in the medium.

Any combination of one or more computer usable or computer readable medium(s) may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), an optical fiber, a portable compact disc read-only memory (CD-ROM), or other tangible optical or magnetic storage device; or transmission media such as those supporting the Internet or an intranet. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer usable or computer readable medium may be any medium that can contain, store, communicate, propagate, or transport the program for use by or in connection with the instruction execution system, platform, apparatus, or device. The computer usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in any combination of one or more programming languages, including an object oriented programming language, such as Java, Smalltalk, C++ and the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable medium produce an article of manufacture including instruction means which implement the function/act specified in the flowchart and/or block diagram block or blocks.

The computer program instructions may also be loaded onto a computer or other programmable data processing apparatus to cause a series of operations to be performed on the computer or other programmable apparatus to produce a computer implemented process such that the instructions which execute on the computer or other programmable apparatus provide processes for implementing the functions/acts specified in the flowchart and/or block diagram block or blocks.

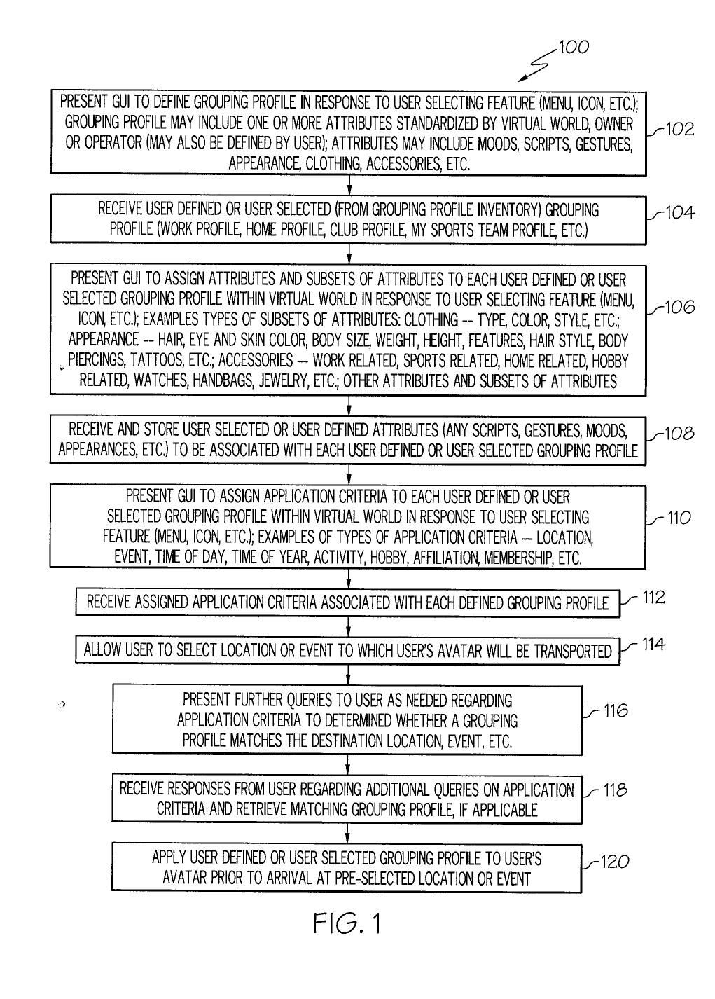

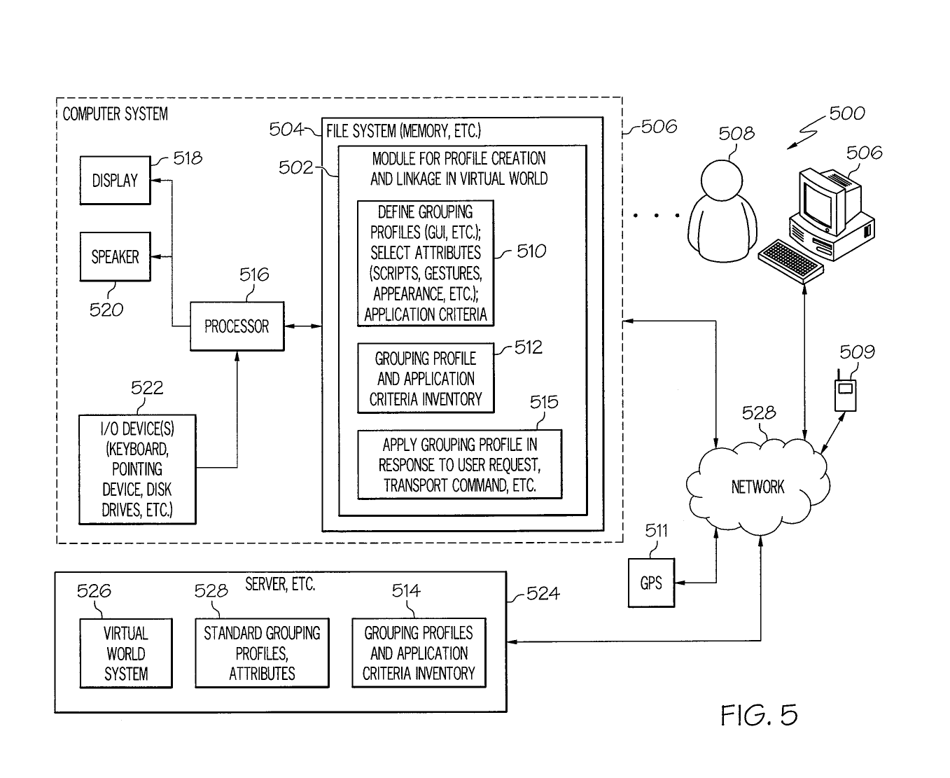

Referring now in more detail to the drawings in which like numbers indicate like parts throughout the several views, FIG. 1 is a flow chart 100 of an example of a method for avatar creating and linking in a virtual world in accordance with an embodiment of the present invention. In block 102, a user interface, such as a graphic user interface (GUI) or other interface may be presented to a user on a display of a computer system, such as display 518 of computer system 506 in FIG. 5, to define a grouping profile or general profile in response to a user selecting a feature in the interface, such as a menu, icon or other feature. The interface may also be presented as a result of a system prompt, such as a system prompt that may be responsive to a user command to transport the avatar to a different location within the virtual world, or responsive to some other action. As such, the system or method 100 may prompt the user to confirm application of an existing grouping profile or apply a different one, or ask the user for additional information to determine whether a particular grouping profile or general profile should be applied.

A grouping profile or general profile may include one or more attributes standardized by a virtual world owner or operator, provided by a virtual world software or system provider, or may be defined by the user. The attributes associated with a particular grouping profile may be applicable to a user's avatar under certain conditions or criteria (application criteria) as described in more detail herein. Examples of attributes may include moods, gestures, appearance, clothing, accessories, equipments, etc. Each of the attributes may also be made up of one or more levels or a hierarchy of subsets of attributes as described herein. A grouping profile may also include criteria or information provided by the user or standardized by the system to help the system or method 100 determine when to apply that profile. Examples of application criteria may include a virtual world location, event, time of day, time of week, time of month, time of year, holiday, occasion, activity, hobby, membership or affiliation in an organization in the virtual world or other criteria or conditions. Different criteria may be grouped to determine applicability to a user's avatar. Accordingly, a grouping profile and the associated attributes may be automatically applied to the user's avatar depending upon the criteria and where the user's avatar may be transported in the virtual world to do or what activity or event the user's avatar may participate in. As described herein, creating and linking of the grouping profile or user profile and application of the profiles may be user driven.

The GUI may be presented in response to the user selecting or clicking-on a menu, icon or other mechanism using a computer pointing device or similar device. For grouping profiles already defined, the menu or icon may display a listing of profiles existing in the system's inventory or user's inventory for selection or editing. For creating a new grouping profile, the user may provide the system with a new definition for the new grouping profile. Once the user defines a grouping profile, the definition may be stored in the system, for example, on a server or other storage arrangement for subsequent retrieval. A user created grouping profile may also optionally be shared with other avatars, if permitted by the user.

In block 104, the user defined or user selected grouping profile may be received by the system and stored on the system. The grouping profile may be selected from a grouping profile inventory of standardized grouping profiles provided by the system owner or operator as previously described or from an inventory of previously created grouping profiles of the user. Examples of grouping profiles may include a work profile, a home profile, a club profile, my sports team profile and other similar profiles. Examples of attributes or subsets of attributes associated with each grouping profile will be described herein.

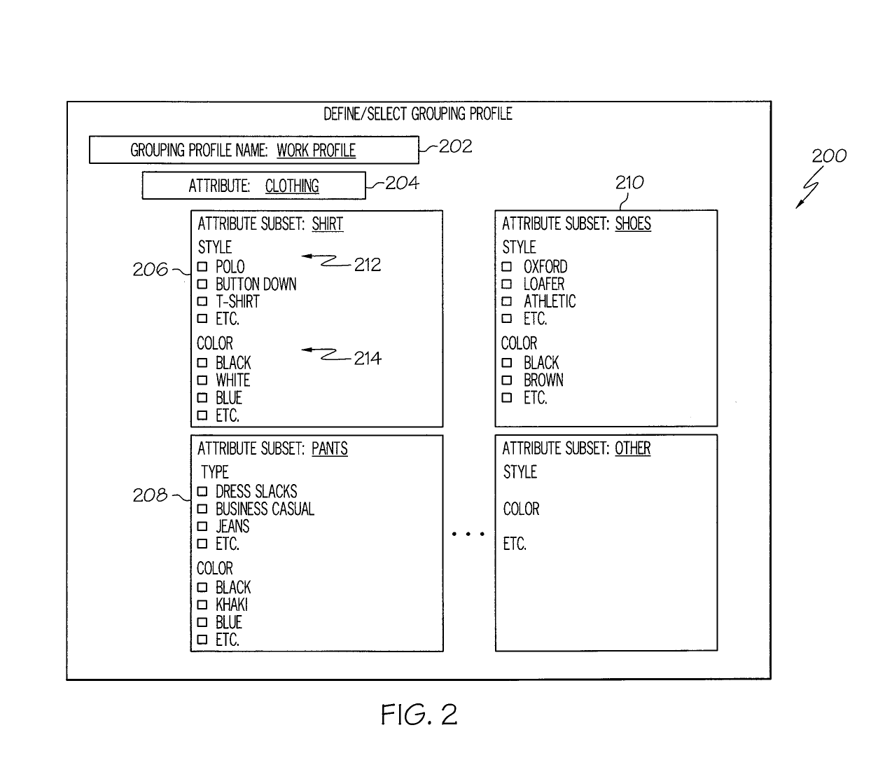

In block 106, the system or method 100 may present a user interface or GUI on a display to allow the user to assign attributes to the previously defined grouping profile. As stated above, attributes may include mood, clothing, accessories, gestures, appearance or other attributes. The attributes may be standardized and accessible through the system inventory, or user defined. Each attribute and subset of an attribute may be assigned through a drop down menu, click-on menu or the like. Alternatively, the user may define a new attribute or subset of an attribute. For example, if the user selects a “work profile” to create, the GUI may present the user with various attributes to select from for assignment to that profile which would be appropriate for that particular profile. In particular, the GUI may present clothing as one subset attribute. Further subsets of clothing might include shirt, pants, shoes, accessories, etc. A further subset of shirt might include color, size and style. A further subset of color might include red, orange, yellow, green, blue, purple, white, black, brown, patterned or other colors. A further subset of patterned might include stripe, plaid, dotted, and the like. It is anticipated that each attribute may have a number of subsets associated therewith. It is also anticipated that each subset may have further subsets associated therewith. The number of subsets could be seemingly endless, especially when related to the area of clothing, appearance, accessories and the like, as there are any number of styles of clothing, jewelry and appearances that an avatar may assume. Thus, the number of attribute subsets may only be limited by the user's and system's imagination as well as memory storage capacity. An example of a GUI for assigning or selecting attributes and subsets of attributes for a grouping profile will be described with reference to FIG. 2.

In assigning attributes, the method 100 may also present the user with a preselected grouping of attributes and subset attributes that may be assigned in their entirety. For example, if a user has defined “work profile” and is an employee of a particular company or business, he or she may select a grouping of attributes related to clothing related to that company or business for assignment to his or her avatar. Such a grouping may accurately reflect the company's dress code and ease the number of selections needed to complete the clothing attributes by the user.

In block 108, the attributes and subsets of attributes may be received and stored within the system or server to be associated with each user defined or user selected grouping profile.

In block 110, the method 100 may present a GUI on a display of a computer system to prompt the user to select an application criteria for assignment to the grouping profile previously assigned. The application criteria may define or set forth parameters for when or under what circumstances a particular grouping profile may be applicable to the user's avatar. Application criteria may include but are not limited to virtual world location, event, time of day, time of year, activity, hobby, or affiliation within the virtual world. As set forth above with respect to the attributes and subsets of attributes, the criteria for assignment to a user defined or user selected grouping profile may be user defined or user selected. For example, in the “work profile” discussed above, the user may be further prompted by the system via a GUI to select a particular location or choose from a number of location options to which the “work profile” would be applied within the virtual world. In particular, the user may be prompted to select from a number of different known locations of user's employer's offices, or may define a new location.

In block 112, the system may receive and store the user selected or user defined application criteria to be associated with each user defined or user selected grouping profile.

In block 114, the method 100 allows the user to select a location or event to which the user's avatar may be transported within the virtual world and to request transport to such location or event. It should be noted that this request may also come in the form of global positioning information provided by the user. For example, if a user created a “work profile” and included certain position coordinates in the criteria for that profile to indicate to the system that if the user indicates that he or she is to be located at those positioning coordinates, then the avatar should be transported to that location and the “work profile” should be applied prior to transport.

In block 116, the method 100 may present a GUI or other prompt that may request further information from the user that may impact the system's ability to retrieve and apply the appropriate grouping profile. Information requested by the system or method 100 may include queries regarding criteria that may be unknown by the system regarding the proposed destination location or event. For example, a user may request transport to a vacation destination. The system may have two or more grouping profiles that relate to vacation destinations. Questions posed to the user by the system or method 100 relating to time of day, time of year, occasion, or similar queries may aid the system in determining which grouping profile to apply prior to transport.

In block 118, the system receives such information provided by user in block 116 and retrieves the appropriate grouping profile in response to the criteria provided by the user as well as the criteria and attributes originally assigned to the grouping profile.

In block 120, the system or method 100 applies the retrieved grouping profile from block 118 and transports the user's avatar to the commanded location or event. If no additional information or queries are needed from the user, the system or method 100 may automatically apply the grouping profile based on a substantial match or substantially close match between the desired location, event or activity and the application criteria associated with the grouping criteria to be applied to the user's avatar. In accordance with another embodiment of the present invention, the user may be provided an opportunity to review and edit the grouping profile before transportation of the user's avatar to the location, event or activity.

FIG. 2 is an example of a GUI 200 for defining, creating or selecting grouping profiles in a virtual world in accordance with an embodiment of the present invention. As illustrated in FIG. 2, each profile, once defined, may have attributes assigned to it. In this example a work profile 202, has been defined as having attributes, such as clothing 204, assigned to this profile. Each attribute may have attribute subsets, such as shirt 206, within the attribute of clothing 204 within the work profile 202. Within each attribute subset 206, there may be items for selection for assignment that are presented via the GUI. For example, under the attribute of clothing 204, there may be subset attributes such as shirt 206, pants 208 and shoes 210. Under the subset attribute of shirt 206, there may be selections for assignment such as “style” 212 (or type), “color” 214 or a second or lower level subset of attributes. Under “type” 212 there may also be a further selection of different types or styles of shirts from an inventory of work profile shirts, such as “polo”, “button down” or “t-shirt”. Accordingly, there may be a tier or hierarchy of levels of subset of attributes. When the user moves to select “pants” 208 as the subset attribute of clothing 204, the GUI could present a list of selections including “type” and “color”. Within those selections, the inventory would present a list of choices for selection under “type” of pants 208. For example, “pants” 208 in a work profile 202 may include “dress slacks”, “business casual”, “jeans” and other types of pants. The user may select from any of the types of pants 208 presented or define a further category for assignment.

Types of different profiles include but are not limited to work, home, health club, dance club, time of day (such as morning or bedtime profile), time of year, type of activity, such as a sport, hobby, organizational membership (such as a church or civic group), holiday profiles (such as a Christmas, Halloween, or a New Year's profile) and the like. The attributes and subset or subsets of attributes selectable for each particular grouping profile would suitable for that profile but may also be definable by the user as appropriate. The system or method may also make suggestions or recommendations to aid the user in selecting attributes and subsets of attributes or a particular grouping profile.

It is anticipated that preconfigured profiles could be offered to potential users as a package for renting or purchasing for a variety of events such as holidays, special events or regular use.

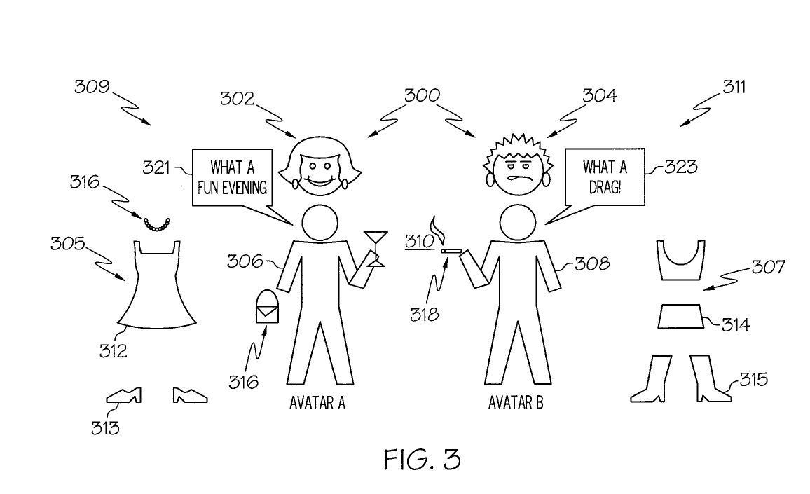

In accordance with another embodiment of the present invention, the group profile may be manually set based on inputs from the user or selection of existing attributes in the attribute inventory by the user. The attributes may be tagged to the avatar or associated with the avatar by a tagging mechanism or visual identifier. FIG. 3 is an illustration of a tagging mechanism 300 or visual identifier to present attributes, such as mood, 302, 304, clothing, 305, 307, overall appearance 309, 311 and accessories 316, 318 in association with a user's avatar 306 or 308 in the virtual world 310 in accordance with an embodiment of the present invention. A mood 302, 304 may be represented by certain facial expression exhibitable by the user's avatar or in association with the user's avatar, such as a happy face or smiley face, a sad face, an angry facial expression or facial expression which connotes a certain mood. Examples of managing and presenting avatar moods in a virtual world are described in U.S. patent application Ser. No. 11/971,508, filed Jan. 9, 2008, entitled “Managing and Presenting Avatar Mood Effects in a Virtual World, which is assigned to the same assignee as the present application and incorporated herein in its entirety by reference.

As illustrated in FIG. 3, a black cocktail dress 312 and black pumps 313 may represent a classical dance club profile for a female avatar 306, and a red mini dress 314 and red high heeled boots 315 may represent a radical dance club profile for a female avatar 308. Further, a happy, petite blonde may further represent the appearance 309 of the classically dressed female dance club profile of a female avatar 306 while a tall, muscular, avatar 308 with short dark-hair and a tattoo on her shoulder may represent the appearance 311 of the radical dance club profile for a female avatar 308. Examples of bodily appearance may include attributes such as body size, body shape, skin color, hair color, hair style, eye color, body piercings, tattoos, and the like. As previously discussed, dance club profile accessories for a female avatar may include but not limited to jewelry, such as a string of pearls 316, a handbag, a glass, or a cigarette 318. These may also be assigned to the dance club profile to further represent the overall appearance of the female avatar either alone or in addition to any other avatar attributes.

Other attributes may include but are not necessarily limited to gestures, scripts 321, 323 and other attributes and subset attributes. Gestures may involve preprogrammed bodily movements or actions which may occur in response to a certain stimuli in the virtual world, such as performance of a certain function or action by another avatar, approach of another avatar, etc. which may call for a responsive gesture by the user's avatar. Examples of generation of gestures and responsive gestures in a virtual world are described in U.S. patent application Ser. No. 12/098,240, filed Apr. 4, 2008, and entitled “Generation of Gesture Responses in a Virtual World, assigned to the same assignee as the present application and incorporated herein in its entirety by reference. Scripts 321, 323 may be represented by predefined text that may be spoken by the avatar under predetermined or defined circumstances or predetermined action by the user. It is envisioned that a menu for each attribute and subsets of attributes would be accessible for application to the avatar during the assignment of attributes and information during the creation or editing of a user grouping profile.

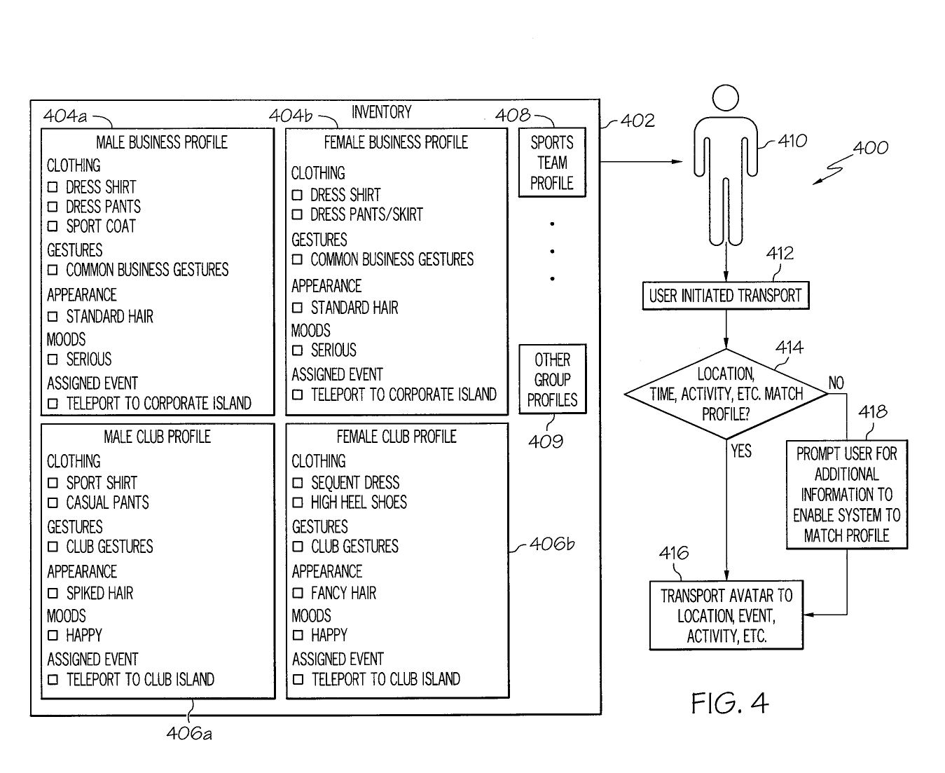

FIG. 4 is an example of a system 400 including a representation of an inventory 402 of grouping profiles and mechanism for linking or associating the profiles based on application criteria in accordance with an embodiment of the present invention. The method 100 may be embodied in and performed by the system 400. The system 400 may include an inventory 402 of grouping profiles, such as a male and female work or business profile 404a and 404b, a male and female club profile 406a and 406b, a sports team profile 408 and other grouping profiles 409, similar to that described above. Each grouping profile, as discussed in detail above, may be created by the user by selecting a predefined profile name already existing in the inventory 402, or by the user defining a new profile name for his or her avatar 410. Also, the user may create the grouping profile by either selecting attributes presently existing in the system inventory 402 or defining new attributes for assignment to the profile. Further information such as location, event, activity, time of day, time of year, holiday, affiliation and the like may also be selected by the user from an existing inventory or defined by the user to be used as an application criteria similar to that previously described to automatically determine which grouping profile may be applied depending upon the criteria being satisfied.

When the system receives a signal from the user commanding transport of his or her avatar to a particular location, activity or event (block 412), the system 400 may compare the requested location, activity or event with its existing inventory 402 of grouping profiles. If substantially all of the criteria apply to a particular grouping profile, then the grouping profile may be applied to the avatar 410 and the avatar 410 may be transported to the requested location, activity or event (block 416). If the criteria for the grouping profile do not substantially match the requested location, activity or event, the process may advance to block 418. In block 418, the user may be prompted to provide additional information to enable the system 400 to match a grouping profile to the avatar. If a grouping profile match is found based on the additional information, the profile may be applied to the avatar 410 and the avatar 410 may be transported to the location, event or activity in block 416. If a matching grouping profile is not found, the avatar 410 may still be transported to the requested location, activity or event 416 without application of any matching profile. The user may be presented an option whether his avatar is transported to the location, activity or event 416 without application of any matching profile or as the user's avatar is currently profiled. In accordance with an embodiment of the present invention, if one or more attributes for the grouping profile match the requested location, activity or event in block 414 or if only a predetermined number of the attributes of a grouping profile match the requested location, activity or event in block 414, the system 400 may prompt the user to provide further information to better enable the system 400 to determine whether a particular grouping profile should be applied to the avatar 410 prior to transport.

FIG. 5 is a block schematic diagram of an example of a system 500 for creating avatar grouping profiles and for linking the profiles in a virtual world in accordance with an embodiment of the present invention. The method 100 of FIG. 1 may be embodied in or performed by the system 500. The system 500 may include a module 502 for creating and linking grouping profiles. The module 502 may be stored on a file system 504 of an exemplary computer system 506. The exemplary computer system 506 may be used by a user, such as user 508, to access or enter a virtual world as described herein. A plurality of users 508 may each use a computer system, similar to the exemplary computer system 506, to participate in the virtual world by controlling an avatar in the virtual world associated with the user 508.

The module 502 for creating and linking user driven grouped profiles in the virtual world may include a sub-module or component 510 to define or select grouping profiles and attributes and sub-attributes to be associated with each grouping profile. The grouping profile defining component 510 may also permit defining or selecting application criteria for applying each of the grouping profiles as described herein. The grouping profile defining component 510 may generate and present a GUI to the user 508 to permit a plurality of profiles to be either selected by the user from a profile inventory 512, or defined by the user and associated with the user's avatar. Previously defined grouping profiles may also be stored in the profile inventory 512. The GUI may include provisions for selecting from a predetermined list of attributes and subsets of attributes, or defining attributes. Attributes may include but not be limited to types of clothing, gestures, appearance, mood, accessories, which may connote the profile of a user's avatar to other users in the virtual world. The GUI may further include provisions for selecting from a predetermined list of information or application criteria or defining criteria that may be assigned to the grouping profile. These criteria may include but not be limited to a particular location, event, time of day, time of year, affiliation or activity similar to that previously described. The application criteria may be used to determine whether a particular grouping profile may be applied to the user's avatar based on the circumstances or the location, activity or event to which the user desires to transport his avatar.

The inventory 512 may store all of the grouping profiles including those predetermined by the system 500, as well as those defined or otherwise created by the user. The inventory 512 may store all of the attributes, such as scripts, gestures or actions, mood, appearances, clothing, accessories or equipment or other attributes associated with each grouping profile for application to the user's avatar. The inventory 512 may also store attribute subsets such as shirt, shoes, pants, jewelry, color of shirt, style of shirt, etc., as discussed in more detail above. The inventory 512 may store criteria information discussed above. Criteria information includes but is not limited to location, event, time of day, time of year, holiday, activity, hobby, and affiliation. As previously discussed, the grouping profiles, associated attributes and subsets of attributes, as well as criteria information may be defined by the user or the virtual world owner and/or operator may define standardized grouping profiles and associated attributes and subsets of attributes and standardized criteria information which may be shared among all avatars in the virtual world.

In another embodiment of the present invention, the module 502 or elements or parts of the module 502 may reside on another component of the system 500, such as at a server 524. Accordingly, a grouping profiles and application criteria inventory 514 may reside on the system 500, such as at a server 524. The inventory 514 may be in lieu of the inventory 512 on the user's computer system 506 or in addition to the inventory 512.

The module for creating and linking avatar grouping profiles 502 in a virtual world may also include a component 515 to apply a particular grouping profile in response to a command to transport the avatar to a new location. For example, when the user commands the system to transport his or her avatar to a particular location within the virtual world, the system 500 or module 502 will determine whether that particular location requires the application of a particular grouping profile prior to transport of the avatar. Criteria for applying a particular grouping profile are within the profile or may prompt a request for further information from the system to determine whether a particular grouping profile should be applied prior to transport.

The computer system 506 may also include a processor 516. The module for creating and linking avatar profiles 502 may be accessed from the file system 504 and run on the processor 516.

The computer system 506 may also include a display 518, a speaker system 520, and one or more input devices, output devices or combination input/output devices, collectively I/O devices 522. The I/O devices 522 may include a keyboard, pointing device, such as a mouse, disk drives and any other devices to permit a user to interface with and control operation of the computer system 506 and to access and participate in the virtual world through the user's avatar. The display 518 may present the user's avatar and other users' avatars in the virtual world and present the features described herein for creating and linking avatar profiles. The speaker 520 may present any sounds associated with the virtual world, such as audible mood effects or other sounds.

As previously mentioned, the system 500 may also include a server 524. A virtual world system 526 may reside and operate on the server 524. Users 508 via browsers (not shown in FIG. 5) on their computer systems 506 may access the virtual world system 526 via a network 528. The network 528 may be the Internet, an intranet or other private or proprietary network.

It should be noted that it is envisioned that users 508 may access a virtual world system 526 by means of a cellular telephone 509, global positioning system (GPS) 511 or other wireless means of communication to provide the system 500 with commands as well as information regarding the user's present location. This may be accomplished, as discussed in detail above, by the user 508 accessing the virtual world system 526 remotely via a cellular telephone 509, GPS 511 or other wireless means of communication, to provide commands to the system 500 regarding the user's avatar, or to provide information to the system 500 regarding user's present location and request the system 500 to transport his or her avatar to that location. Where the user 508 is providing location information and commanding the system 500 to transport his or her avatar, the user 508 may have previously created a grouping profile applicable to his or her present location. By inputting this data and transport request into the system 500 or virtual world system 526, the system 500 can automatically transport the user's avatar to that location and apply the particular grouping profile. Alternatively, the user 508 may create bookmarks or favorite grouping files for easy retrieval on the user's wireless communication device (cellular telephone, GPS, etc.). In such cases, the user 508 may access the virtual world system 526 remotely via cellular telephone 509, GPS 511 or other wireless means and provide the system 500 with location information as well as request application of a particular grouping profile that may be in his or her bookmarked page or list of favorites. In this scenario, the user 508, and not the virtual world system, is determining which grouping profile to apply prior to transport.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for creating and linking a profile in a virtual world, comprising:
presenting an interface for creating a grouping profile for application to a user's avatar in response to the user's avatar to be transported to one of a particular virtual world location, event and activity, wherein the grouping profile includes at least one attribute;
allowing assignment of the at least one attribute to the grouping profile;
allowing definition of an application criteria; and
associating the application criteria with the grouping profile, wherein the application criteria is usable to determine if the grouping profile is applicable to the user's avatar based on the one of the particular virtual world location, event and activity to which the user's avatar is to be transported.

2. The method of claim 1, wherein presenting the interface for creating a grouping profile comprises presenting a menu of existing predefined grouping profiles for selection.

3. The method of claim 2, wherein the menu of existing predefined grouping profiles for selection comprises a grouping profile for the user's avatar at work and business purposes, a grouping profile for the user's avatar playing a sport, a grouping profile for the user's avatar at home, and a grouping profile for the user's avatar going to a night club in the virtual world.

4. The method of claim 1, wherein presenting the interface for creating a grouping profile comprises permitting a user to define a new grouping profile.

5. The method of claim 1, wherein allowing assignment of the at least one attribute to the grouping profile comprises allowing the user to define a new attribute.

6. The method of claim 1, wherein allowing assignment of the at least one attribute to the grouping profile comprises presenting a menu of existing predefined attributes for selection.

7. The method of claim 1 wherein the at least one attribute comprises an attribute related to clothing wearable by the user's avatar, an attribute related to a mood associable with the user's avatar, an attribute related to a gesture performable by the user's avatar, an attribute for a script useable by the user's avatar, an attribute related to an appearance acquirable by the user's avatar, an attribute related to an accessory useable by the user's avatar, and an attribute related to equipment useable by the user's avatar.

8. The method of claim 1, further comprising allowing association of at least one subset of attributes with the at least one attribute.

9. The method of claim 8, wherein the at least one subset of attributes comprises a shirt, pants, and shoes associable with a clothing attribute.

10. The method of claim 8, further comprising allowing association of at least a second level subset of attributes with the at least one attribute.

11. The method of claim 1, wherein allowing definition of the application criteria comprises associating at least one of a virtual world location, virtual world event and a virtual world activity with the grouping profile.

12. The method of claim 1, wherein allowing definition of the application criteria comprises defining at least one of a time of day, a time of year, a time of week, and time of month for association with the grouping profile.

13. The method of claim 1, wherein allowing definition of the application criteria comprises allowing association of at least one of a hobby, a sport, an affiliation with an organization and a membership in an organization with the grouping profile

14. The method of claim 1, further comprising allowing a user to select one of the virtual world location for the user's avatar to be transported to; a virtual world event for the user's avatar to attend; and a virtual world activity for the user's avatar to participate in.

15. The method of claim 14, further comprising applying the grouping profile prior to one of transporting the user's avatar to the virtual world location; the user's avatar attending the event; and the user's avatar participating in the activity.

16. The method of claim 1, further comprising presenting a query to the user in response to requiring additional information to match a grouping profile to the particular virtual world location, event and activity.

17. A system for creating and linking a profile in a virtual world, comprising:
a processor;
a module operable on the processor for creating and linking a grouping profile in the virtual world;
an interface presentable by the module for creating a grouping profile for application to a user's avatar in response to the user's avatar to be transported to one of a particular virtual world location, event and activity, wherein the grouping profile includes at least one attribute;
wherein the module allows assignment of the at least one attribute to the grouping profile, allows definition of an application criteria; and
wherein the module permits association of the application criteria with the grouping profile, wherein the application criteria is usable to determine if the grouping profile is applicable to the user's avatar based on one of the particular virtual world location, event and activity to which the user's avatar is to be transported.

18. The system of claim 17, wherein the at least one attribute comprises an attribute related to clothing wearable by the user's avatar, an attribute related to a mood associable with the user's avatar, an attribute related to a gesture performable by the user's avatar, an attribute for a script useable by the user's avatar, an attribute related to an appearance acquirable the user's avatar, an attribute related to an accessory useable by the user's avatar, an attribute related to equipment useable by the user's avatar.

19. A computer program product for creating and linking a profile in a virtual world, the computer program product comprising:
a computer usable medium having computer usable program code embodied therein, the computer usable medium comprising:
computer usable program code configured to present an interface for creating a grouping profile for application to a user's avatar in response to the user's avatar to be transported to one of a particular virtual world location, event and activity, wherein the grouping profile includes at least one attribute;
computer usable program code configured to allow assignment of the at least one attribute to the grouping profile;
computer usable program code configured to allow definition of an application criteria; and
computer usable program code configured to associate the application criteria with the grouping profile, wherein the application criteria is usable to determine if the grouping profile is applicable to the user's avatar based on the one of the particular virtual world location, event and activity to which the user's avatar is to be transported.

20. The computer program product of claim 19, further comprising computer usable program code configured to present a menu of existing predefined grouping profiles for selection, the menu comprising a grouping profile for the user's avatar at work and business purposes, a grouping profile for the user's avatar playing a sport, a grouping profile for the user's avatar at home, and a grouping profile for the user's avatar going to a night club in the virtual world.
